(19) United States
(12) Patent Application Publication
(10) Pub. No.: US 2012/0141073 A1
(43) Pub. Date: Jun. 7, 2012

(54) OPTICAL SUB-ASSEMBLY WITH STRAIN RELIEF FEATURE

(75) Inventors: Richard Mainardi, Hudson (CA); David R. Rolston, Beaconsfield (CA)

(73) Assignee: Reflex Photonics inc., Montreal (CA)

(21) Appl. No.: 12/958,051

(22) Filed: Dec. 1, 2010

(51) Int. Cl. G02B 6/36

(52) U.S. Cl. 385/78

(57) ABSTRACT

The present document describes an optical interconnect module for interfacing optical fibers. An optical interconnect module in accordance with an embodiment comprises a casing including a projection and an optical sub-assembly including an interlock portion for receiving the projection of the casing. The optical sub-assembly carries a plurality of optical fibers, and couples face to face with an optical cable assembly for aligning the corresponding fibers together. The optical cable assembly is usually provided in an optical cable connector, along with a spring which compresses when the optical cable connector is inserted in the optical interconnect module. The pressure provided by the spring is transmitted to the optical sub-assembly. The optical sub-assembly applies this pressure to the projection received in the notch thereof for maintaining a tight engagement with the optical cable assembly. With this arrangement it is possible shorten the optical sub-assembly, save circuit board space and reduce the length of the optical fibers, which results in optical interconnect modules which may achieve high speed short-reach optical data connectivity in a small form factor and at low cost.

### BACKGROUND

(a) Field

The subject matter disclosed relates to the field of opto-electrical connection devices. More particularly, it relates to devices for interconnecting optical fibers.

(b) Related Prior Art

Optical interconnect modules are widely used in the field of optical telecommunication for connecting different optical fibers so that the laser emitted in one fiber is transmitted to the other fiber with the least possible amount of losses in signal strength and light dispersion. Optical interconnect modules comprise a circuit board including an optical connector assembly for processing/converting optical and electric signals.

FIG. 1 is a top plan view of a conventional optical interconnect module 100.

An optical interconnect module 100 such as that shown in FIG. 1 includes an optical ferrule 102 for coupling with a optical cable assembly provided in the optical cable connector to be inserted in the optical interconnect module 100 (not shown in FIG. 1).

The optical ferrule of the optical cable connector and that of the optical interconnect module 100 constitute a male-female match, whereby the male ferrule such as the ferrule 102 shown in FIG. 1 includes at least one male-projection 104 to be received by an opening in the female ferrule in order to align the corresponding optical fibers of the two optical ferrules with each other.

FIG. 2 is an isometric view of a conventional ferrule 106. In this example, the ferrule 106 is a female ferrule having two openings 108 for receiving the male-projections 104 of the male-ferrule 102 for aligning the corresponding fibers with each other. Each ferrule includes an opening 110 provided on one side thereof for filling the ferrule with glue after inserting the fibers in a hollow portion of the optical ferrule, so that the fibers remain in place during cutting.

In order to maintain the two optical ferrules in a tight engagement when an optical cable connector (not shown) is inserted in the optical interconnect module 100, a positive pressure is applied by the optical cable connector of the optical cable assembly onto the optical ferrule 102 of the optical interconnect module 100. This pressure is usually provided by a spring which presses onto the ferrule of the optical cable connector to keep the two optical ferrules in tight engagement.

For instance, in the example of FIG. 1, the pressure will be applied on the male-ferrule 102 by the female ferrule of the optical cable connector (which is not shown). In order for the male-ferrule to resist the pressure without being dislocated, and without ruining the fibers 112 and/or the optical connector assembly 114 provided on the circuit board 115, a member 116 is provided which acts like a bridge between the male ferrule 102 and projections 118 provided in the casing of the optical interconnect module 100.

This way, when the female-ferrule is coupled to the male-ferrule 102, and the spring provides a positive bias toward the circuit board 115 as indicated by arrow 120, the female ferrule of the an optical cable connector and the male ferrule 102 remain in a tight engagement and the corresponding fibers remain aligned with each other.

However, this mechanism results in optical interconnect modules having large unused board space 122, and un-necessarily long fibers 112 which are not suitable for short-reach optical data connectivity.

### SUMMARY

According to an aspect, there is provided an optical sub-assembly adapted to interface with an optical cable assembly. The optical sub-assembly is for installation within a casing. The optical sub-assembly comprises optical fibers having an axis and an interlock portion for interaction with the casing, the interaction between the interlock portion and the casing being sufficient to resist a pressure exerted on the optical sub-assembly in a direction corresponding to the axis thereby relieving the strain applied on the optical sub-assembly.

According to another aspect, there is provided an optical interconnect module for interfacing with an optical cable assembly comprising optical fibers. The optical interconnect module comprising: a casing for receiving the optical cable; and an optical ferrule adapted to interface with the optical cable assembly. The optical sub-assembly comprising optical fibers and an interlock portion for interaction with the casing. The interaction between the interlock portion and the casing being sufficient to resist a pressure exerted on the optical sub assembly by the optical cable assembly thereby relieving the strain applied on the optical sub-assembly while maintaining the optical sub-assembly and the optical cable assembly in a tight engagement.

Features and advantages of the subject matter hereof will become more apparent in light of the following detailed description of selected embodiments, as illustrated in the accompanying figures. As will be realized, the subject matter disclosed and claimed is capable of modifications in various respects, all without departing from the scope of the claims. Accordingly, the drawings and the description are to be regarded as illustrative in nature, and not as restrictive and the full scope of the subject matter is set forth in the claims.

### BRIEF DESCRIPTION OF THE DRAWINGS

Further features and advantages of the present disclosure will become apparent from the following detailed description, taken in combination with the appended drawings, in which:

FIG. 1 is a top plan view of a conventional optical interconnect module;

FIG. 2 is an isometric view of a conventional optical ferrule;

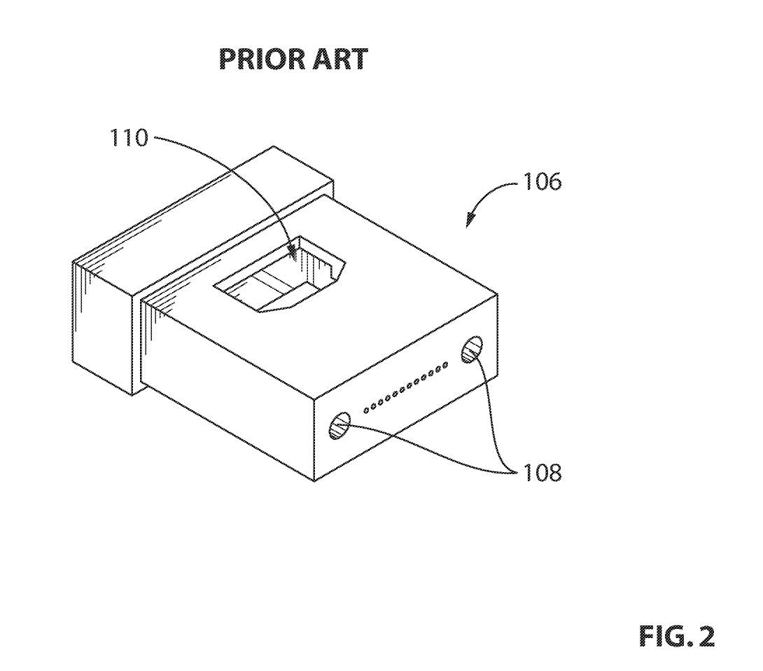

FIG. 3 is a top plan view of an optical interconnect module connected to an optical cable connector, according to an embodiment; and

FIG. 4 is an isometric view of an optical ferrule in accordance with an embodiment.

It will be noted that throughout the appended drawings, like features are identified by like reference numerals.

### DETAILED DESCRIPTION

An embodiment discussed herein describes an optical interconnect module for interfacing optical fibers. An optical interconnect module in accordance with an embodiment comprises a casing including a projection and an optical sub-assembly including a notch for receiving the projection of the casing.

The optical sub-assembly carries a plurality of optical fibers, and couples face-to-face with an optical cable assembly for aligning the corresponding fibers together. The optical cable assembly is usually provided with an optical cable connector, along with a spring which compresses when the optical cable connector is inserted in the optical interconnect module.

The pressure provided by the spring is applied to the optical ferrule included in the optical cable assembly. The pressure is transmitted to the optical sub-assembly of the optical interconnect module. The optical sub-assembly applies this pressure to the projection received in the notch thereof for maintaining a tight engagement with the other optical cable assembly.

With this arrangement it is possible to position the optical ferrule closer or in contact with the optical connector assembly and save circuit board space and reduce the length of the optical fibers, which results in optical interconnect modules which may achieve high speed short-reach optical data connectivity in a small form factor and at low cost.

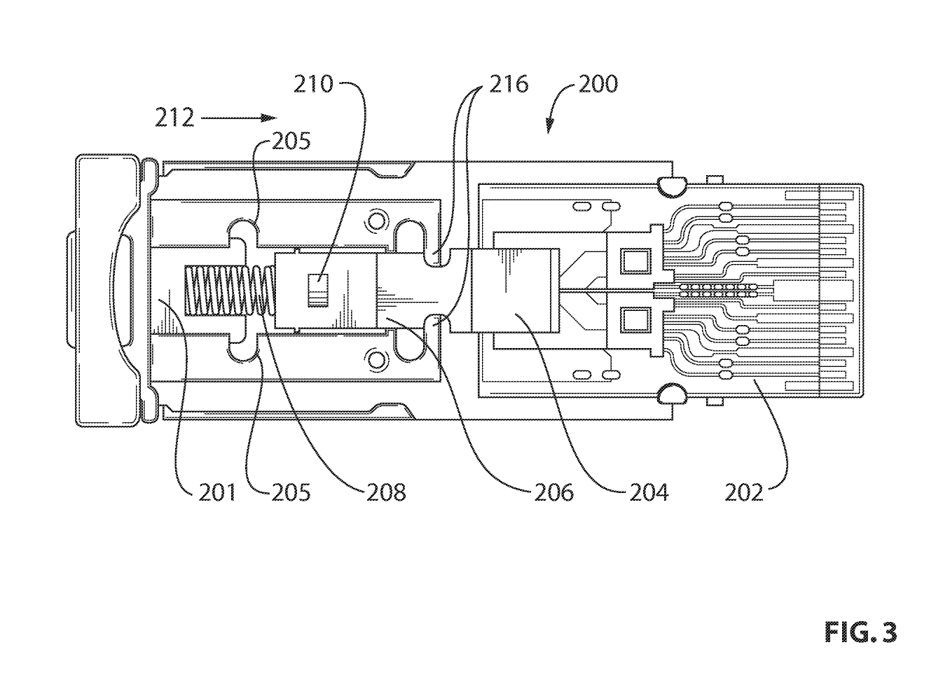

Now referring to the drawings, FIG. 3 is a top plan view of an optical interconnect module 200 connected to an optical cable connector 201, in accordance with an embodiment.

As shown in the embodiment of FIG. 3, the optical interconnect module 200 comprises a circuit board 202 including an optical connector assembly 204 (e.g., a Silicon V-Groove Chip), and an optical ferrule 206. The optical connector assembly 204 and the optical ferrule 206 form the optical sub-assembly. The optical interconnect module 200 also comprises an opto-electrical conversion device (not shown). The opto-electrical conversion device converts electrical signal to optical signals (e.g., laser diode, VCSEL) in a transmitter application or converts optical signals to electrical signals (e.g., a photo-detector device, photodiode) in a receiver application.

The optical cable assembly includes an optical cable connector 201, a spring 208 and a cable optical ferrule 210. The spring 208 is in direct contact with the cable optical ferrule 210, for providing positive pressure as indicated by arrow 212 to keep the cable optical ferrule 210 of the optical cable connector 201, and the optical ferrule 206 of the optical interconnect module 200 in a tight engagement when the optical cable connector 201 is inserted in the optical interconnect module 200.

When the optical cable connector 201 is pushed into the optical interconnect module 200, a pressure is applied on the spring 208 which snaps the optical cable connector 201 in position when it reaches the notches 205 provided in the casing the optical interconnect module 200. The pressure is transferred from the spring 208 to the cable optical ferrule 210 of the optical cable connector 201 and thereby, to the optical ferrule 206 of the optical interconnect module 200.

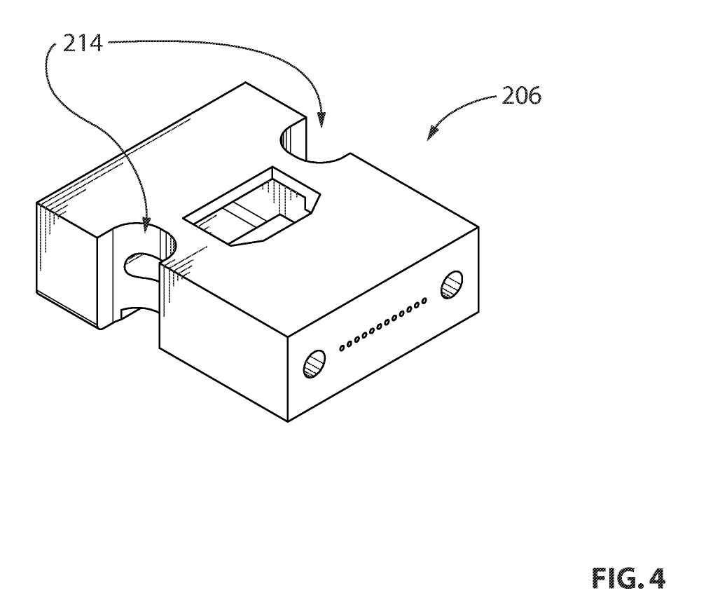

FIG. 4 is an isometric view of an optical ferrule in accordance with an embodiment. According to a general embodiment, the optical ferrule 206 is adapted to interface with an optical cable assembly (not numbered). The optical ferrule 206 is for installation within a casing (not numbered). The optical ferrule 206 comprises a body (not numbered) for carrying optical fibers (not shown) having an axis.

The body comprises an interlock portion (here represented by notches 214) for interaction with the casing. The interlock portion could also be embodied in one or more projections which interact with the casing. The interaction between the interlock portion and the casing is sufficient to resist a pressure exerted on the optical ferrule 206 in a direction corresponding to the axis; i.e., direction 212.

As shown in FIG. 4, the optical ferrule 206 is provided with notches 214 for receiving corresponding projections 216 provided in the casing of the optical interconnect module 200 for applying the pressure of the spring on the projections as shown in FIG. 3, in order to prevent the pressure from being transmitted to the optical connector assembly 204 and the circuit board 202.

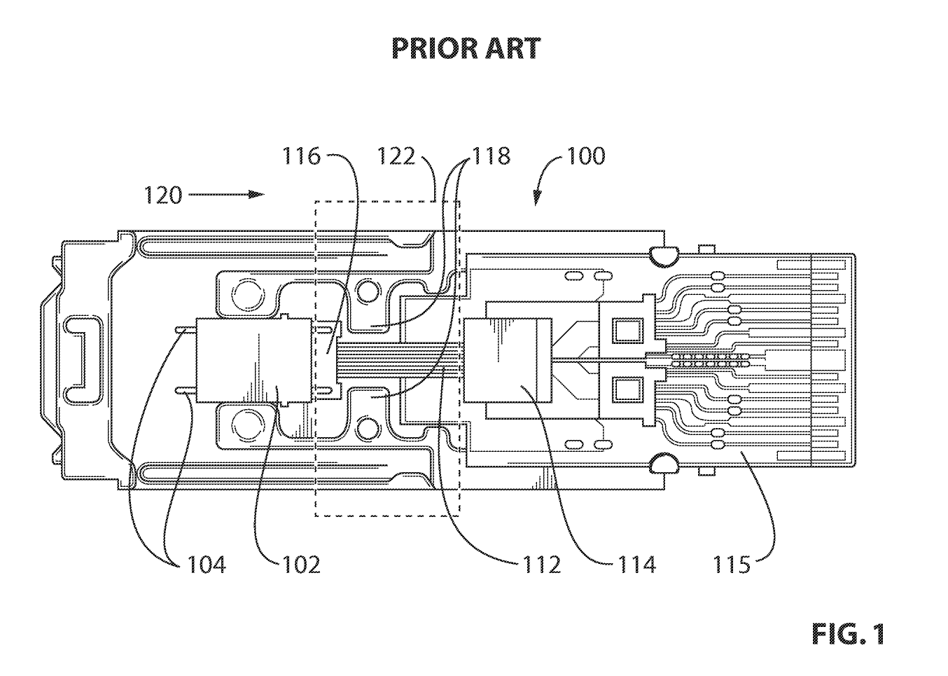

In an embodiment, the optical connector assembly 204 is in direct contact with the optical ferrule 206, whereby the space 122 between the optical connector assembly 114 and the ferrule 102 of FIG. 1 is reduced, and the member 116 is eliminated. Furthermore, the length of the optical fibers needed in the optical interconnect module 200 is less than that used in the conventional optical connector assembly 100 shown in FIG. 1.

The optical interconnect module 200 exemplified in FIG. 3 may achieve high speed short-reach optical data connectivity in a small form factor and at low cost.

The body of the optical ferrule 206 comprises two ends through which the optical fibers respectively enter and exit and wherein the interlock portion is located between the two ends. The ferrule further comprises two opposite sides between the two ends. Each one of the two opposite sides has a notch.

The optical fibers, for installation a hollow portion of the optical ferrule 206, each have a flat end. One of the two ends of the optical ferrule 206 comprises a flat portion. When installed in the optical ferrule 206, the flat ends of the optical fibers are flush with the flat portion of the optical ferrule 206.

According to an embodiment the optical ferrule 206 comprises, at the end of the body comprising the flat portion, holes adapted to receive pins (i.e., a pin and hole combination) for alignment with the cable optical ferrule.

An optical interconnect module in accordance with the embodiments described herein is ideal for high-speed data communications and computing applications where very short reach bandwidth bottlenecks are incumbent because, the optical interconnect module 200 exemplified above is smaller in size, occupies less board space, and requires fewer components and shorter fibers.

While preferred embodiments have been described above and illustrated in the accompanying drawings, it will be evident to those skilled in the art that modifications may be made without departing from this disclosure. Such modifications are considered as possible variants comprised in the scope of the disclosure.

1. An optical sub-assembly adapted to interface with an optical cable assembly, the optical sub-assembly for installation within a casing, the optical sub-assembly comprising:
optical fibers having an axis;
an interlock portion for interaction with the casing, the interaction between the interlock portion and the casing being sufficient to resist a pressure exerted on the optical sub-assembly in a direction corresponding to the axis thereby relieving the strain applied on the optical sub-assembly.

2. The optical sub-assembly of claim 1, further comprising a body for carrying the optical fibers and for providing a contact with the optical cable assembly.

3. The optical sub-assembly of claim 2, wherein the body comprises two ends through which the optical fibers respectively enter and exit and wherein the interlock portion is located between the two ends.

4. The optical sub-assembly of claim 3, wherein the interlock portion comprises at least two notches.

5. The optical sub-assembly of claim 4, wherein the body comprises two opposite sides between the two ends, each one of the two opposite sides having at least one of the at least two notches.

6. The optical sub-assembly of claim 3, wherein the optical fibers each have a flat end, wherein one of the two ends comprises a flat portion, the flat ends of the optical fibers being flush with the flat portion

7. The optical sub-assembly of claim 6, wherein optical sub-assembly comprises, at the end of the body comprising the flat portion, holes adapted to receive pins for alignment with the optical cable assembly.

8. The optical sub-assembly of claim 2, wherein the body further comprises a hollow portion in which the optical fibers are secured.

9. The optical sub-assembly of claim 1, wherein the interlock portion comprises at least one of a notch and a projection.

10. The optical sub-assembly of claim 1, further comprising an optical connector assembly, which comprises the interlock portion.

11. An optical interconnect module for interfacing with an optical cable assembly comprising optical fibers, the optical interconnect module comprising:
a casing for receiving the optical cable assembly; and
an optical sub-assembly adapted to interface with the optical cable assembly, the optical sub-assembly comprising optical fibers and an interlock portion for interaction with the casing, the interaction between the interlock portion and the casing being sufficient to resist a pressure exerted on the optical sub-assembly by the optical cable assembly thereby relieving the strain applied on the optical sub-assembly while maintaining the optical sub-assembly and the optical cable assembly in a tight engagement.

12. The optical interconnect module of claim 11, wherein the optical sub-assembly and the optical cable assembly comprise a pin and hole combination for aligning the corresponding optical fibers in the optical cable assembly and the optical sub-assembly.

13. The optical interconnect module of claim 11, further comprising an opto-electrical conversion device and an optical connector assembly redirecting light to or from the opto-electrical to the optical fibers.

14. The optical interconnect module of claim 13, wherein the optical sub-assembly is in direct contact with the optical connector assembly.

15. The optical sub-assembly of claim 11, further comprising a body for carrying the optical fibers and for providing a contact with the optical cable assembly.

16. The optical interconnect module of claim 15, wherein the body comprises two ends through which the optical fibers respectively enter and exit and wherein the interlock portion is located between the two ends.

17. The optical interconnect module of claim 16, wherein the interlock portion comprises at least two notches.

18. The optical interconnect module of claim 17, wherein the body comprises two opposite sides between the two ends, each one of the two opposite sides having at least one of the at least two notches.

19. The optical interconnect module of claim 11, wherein the interlock portion comprises at least one of a notch and a projection.

20. The optical interconnect module of claim 11, wherein the optical sub-assembly further comprises an optical connector assembly, which comprises the interlock portion.
